(19) United States
(12) Patent Application Publication
(10) Pub. No.: US 2011/0199789 A1
(43) Pub. Date: Aug. 18, 2011

(54) LIGHT SOURCE APPARATUS

(75) Inventors: Ching-Chou Huang, Hsin-Chu (TW); Han-Wen Tsai, Hsin-Chu (TW); Chin-Ming Lin, Hsin-Chu (TW)

(73) Assignee: CORETRONIC CORPORATION, Hsin-Chu (TW)

(21) Appl. No.: 13/006,442

(22) Filed: Jan. 14, 2011

(30) Foreign Application Priority Data
Feb. 12, 2010 (TW) 99203301

(51) Int. Cl. F21V 13/02; F21V 8/00

(52) U.S. Cl. 362/616; 362/551; 362/554

(57) ABSTRACT

A light source apparatus including a light source, an optical fiber, a light guide module, and a light shape adjustment element is provided. The light source emits a light beam. The optical fiber disposed in a transmission path of the light beam has a light incident end and a light emitting end. The light beam enters the optical fiber through the light incident end and leaves the optical fiber through the light emitting end. The light guide module has a first surface, a second surface opposite to the first surface, and a light incident surface connecting the first surface and the second surface. The light beam from the light emitting end enters the light guide module through the light incident surface. The light shape adjustment element is connected to the light guide module and capable of changing a light shape of an emitted light from the light guide module.

### CROSS-REFERENCE TO RELATED APPLICATION

This application claims the priority benefit of Taiwan application serial no. 99203301, filed on Feb. 12, 2010. The entirety of the above-mentioned patent application is hereby incorporated by reference herein and made a part of this specification.

### BACKGROUND OF THE INVENTION

1. Field of Invention

The invention is related to a light source apparatus, and more particularly, to a light source apparatus capable of adjusting the light shape of the emitted light.

2. Description of Related Art

A conventional table lamp or a conventional floor lamp usually has a base and a lampshade, wherein the base is connected to the lampshade through a supporting holder. In addition, a fluorescent lamp, a light emitting diode, or an incandescent bulb is disposed in the lampshade. Some of the table lamps or the floor lamps are configured with an optical film to improve the intensity distribution of the emitted light. However, the position of the fluorescent lamp, the light emitting diode, or the incandescent bulb relative to the lampshade is fixed and the position of the optical film relative to the lamp shade is also fixed. A user may not adjust the light shape of the emitted light of the table lamp or the floor lamp according to his or her requirement.

Furthermore, the fluorescent lamp, the light emitting diode, or the incandescent bulb is disposed in the lampshade and the lampshade is supported by the supporting holder in a distance separated from the floor. Therefore, the heat generated in the lamp and the lampshade mostly dissipates through the air, and thereby, the heat-dissipation efficiency is limited. In addition, the lampshade is usually located near the head of the user so that the user may feel the surrounding temperature increasing due to the heat generated in the lamp and the lampshade when the user uses the table lamp or the floor lamp.

Moreover, the common illuminating lamp fixed on the wall, the ceiling, or the cabinet similarly has the problem of incapability in changing the light shape of the emitted light.

Taiwan patent No. M365863 discloses a multi-tubes single-light-source lamp including a light emitting element and at least two lamp tubes. An end of the light emitting element is connected to an end of a power line, and the other end of the power line is connected to a battery to provide the power to the light emitting element. The lamp tube includes a lens set inside, wherein each lamp tube receives an optical fiber and the terminal of the optical fiber emits the light. The incident light is treated by a focusing and diverging optical treatment through the lens set to achieve the needed coverage.

FIG. 8 of Taiwan patent No. M263504 shows a plurality of optical fibers having side-type light conducting end, wherein the optical fibers are arranged parallel to each other in a hollowing region configured in the object.

FIG. 4 of U.S. Pat. No. 6,801,270 illustrates an optical fiber used for receiving a light from a light source and rendering the light evenly distributed on a reflective layer. The reflective layer may reflect at least 95% of the light to provide a uniform illumination with high brightness.

FIG. 1 of U.S. Pat. No. 6,908,204 illustrates a light emitting system including a light source, a plurality of light guide tubes, and a plurality of light emitting surfaces. The light source generates a light and the light guide tubes transmit the light from the light source to the light emitting surfaces.

### SUMMARY OF THE INVENTION

The invention is directed to a light source apparatus, wherein the light shape of the emitted light of the light source apparatus is capable of being adjusted to form illuminating regions with different area, different shapes, and different illuminance distribution.

Other objects and advantages of the invention may be further illustrated by the technical features broadly embodied and described as follows.

In order to achieve at least one of the objects or other objects, one embodiment of the invention provides a light source apparatus including at least one light source, at least one optical fiber, a light guide module, and a light shape adjustment element. The light source is capable of emitting a light beam. The optical fiber is disposed in a transmission path of the light beam and has a light incident end and a light emitting end opposite to the light incident end. The light beam is capable of entering the optical fiber through the light incident end and leaving the optical fiber through the light emitting end. The light guide module has at least one first surface, at least one second surface opposite to the first surface, and at least one light incident surface connecting the first surface and the second surface. The light beam from the light emitting end is capable of entering the light guide module through the light incident surface. The light shape adjustment element is connected to the light guide module and capable of changing a light shape of an emitted light from the light guide module.

In summary, the embodiment or embodiments of the invention may have at least one of the following advantages: the light source apparatus in an embodiment of the invention has a light shape adjustment element connected to the light guide module and the light shape adjustment element is capable of changing the light shape of the emitted light from the light guide module. Accordingly, a user may change the light shape of the emitted light of the light source apparatus in an embodiment of the invention through operating the light shape adjustment element to form illuminating regions having different shapes and different illuminance distributions.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic view showing a structure of a light source apparatus according to an embodiment of the invention.

FIG. 1B is a schematic cross-sectional view of the light source apparatus in FIG. 1A along line I-I.

FIG. 1C is a schematic view showing the connection of the optical fiber bundle and the light guide module in FIG. 1A.

FIG. 2 is a schematic cross-sectional view of a light shape adjustment element, a reflective element, and a fixing frame of a light source apparatus according to another embodiment of the invention.

FIG. 3A is a schematic view showing a structure of a light source, a lens array, and optical fibers of a light source apparatus according to yet another embodiment of the invention.

FIG. 3B illustrates a top view diagram of the lens array in FIG. 3A and shows a corresponding relationship between the lens array in FIG. 3A and the positions of incident ends of optical fibers.

FIG. 4A is a schematic view showing a structure of a light source apparatus according to still another embodiment of the invention.

FIG. 4B is a schematic cross-sectional view of the light source apparatus in FIG. 4A along line II-II.

FIG. 5 is a schematic view showing a structure of a light guide sheet and a light shape adjustment element in a light source apparatus according to yet still another embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

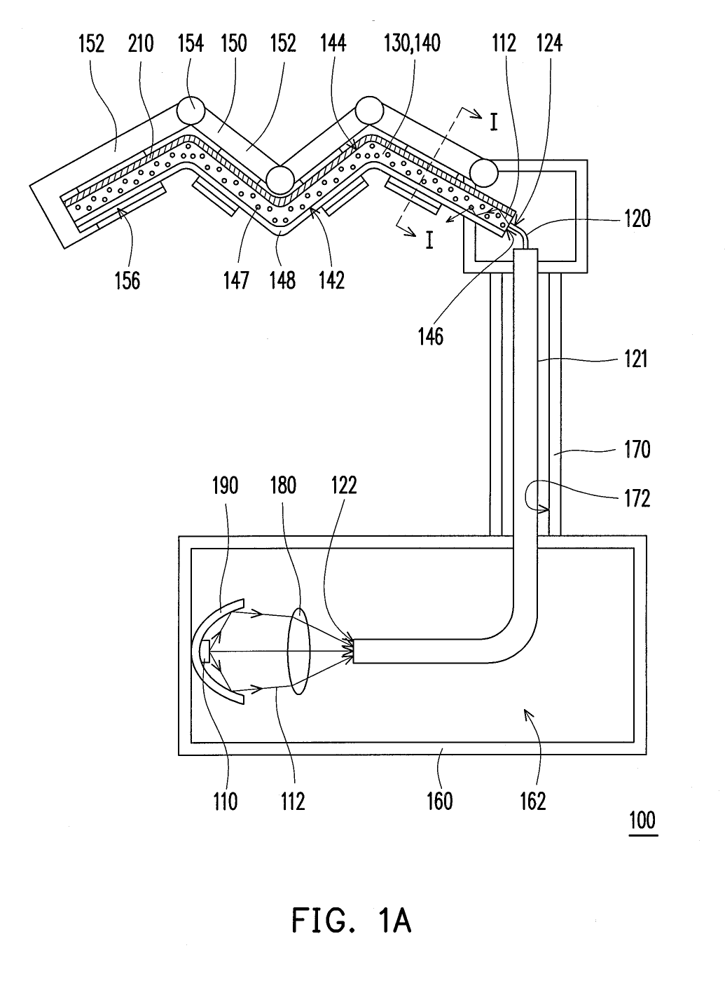

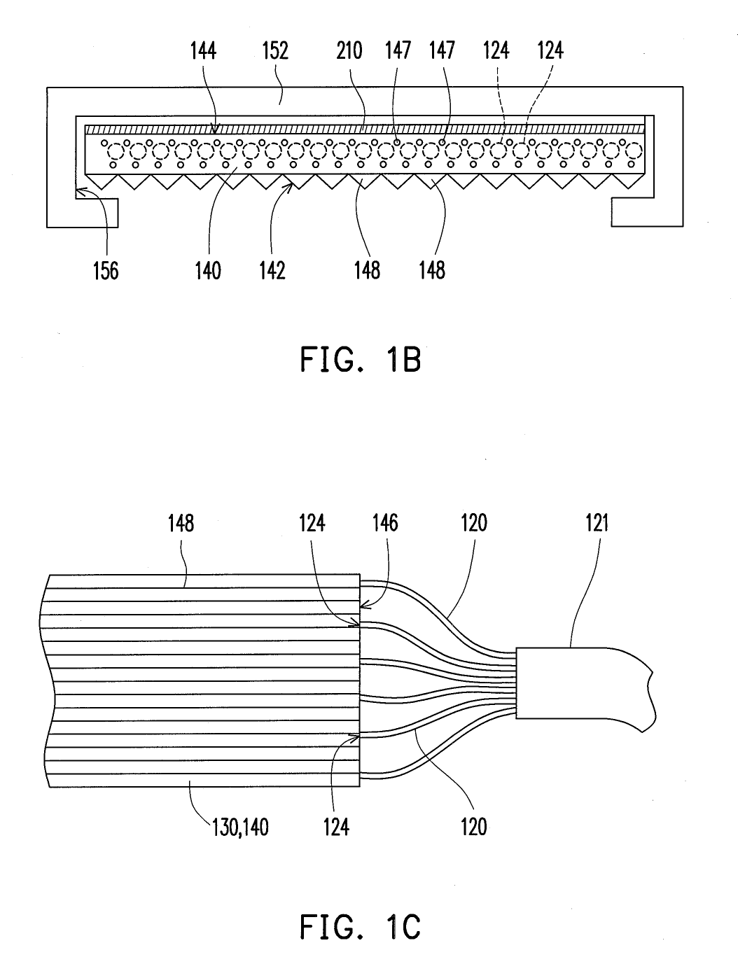

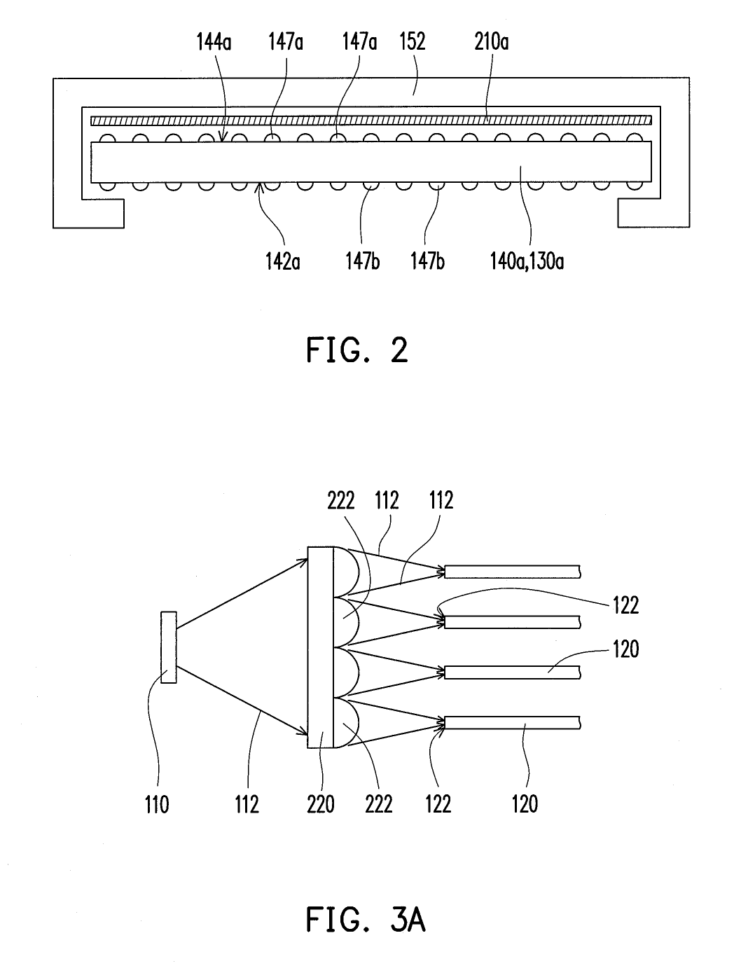

Referring to FIG. 1A to FIG. 1C, a light source apparatus 100 of the embodiment includes at least one light source 110 (one light source 110 shown in FIG. 1A is exemplified), at least one optical fiber 120 (a plurality of optical fibers 120 shown in FIG. 1C are exemplified), a light guide module 130, and a light shape adjustment element 150. The light source 110 is capable of emitting a light beam 112. In the embodiment, the light source 110 is, for example, a light emitting module including a light emitting diode (LED) array. However, in other embodiments, the light source 110 may be a fluorescent lamp, a halide lamp, a single LED, or other suitable light sources.

The optical fiber 120 is disposed in a transmission path of the light beam 112. Each of the optical fibers 120 has a light incident end 122 and a light emitting end 124 opposite to the light incident end 122. The light beam 112 is capable of entering the optical fiber 120 through the light incident end 122 and leaving the optical fiber 120 through the light emitting end 124. In the embodiment, the optical fibers 120 form an optical fiber bundle 121.

The light guide module 130 has at least one first surface 142, at least one second surface 144 opposite to the first surface 142, and at least one light incident surface 146 connecting the first surface 142 and the second surface 144 (one first surface 142, one second surface 144, and one light incident surface 146 shown in FIG. 1A are exemplified). The light beam 112 from the light emitting end 124 is capable of entering the light guide module 130 through the light incident surface 146. In the embodiment, the light guide module 130 is, for example, a flexible light guide sheet 140, and the flexible light guide sheet 140 has the first surface 142, the second surface 144, and the light incident surface 146.

In the embodiment, the light emitting ends 124 of the optical fibers 120 are arranged beside the light incident surface 146 along a straight line, and the straight line is, for example, parallel to the light incident surface 146 and the second surface 144. Accordingly, the light beam 112 emitted from the light emitting ends 124 enters the flexible light guide sheet 140 in a scattered manner to enhance the uniformity of light distribution. In the embodiment, the light emitting ends 124 of the optical fibers 120 are connected to the light incident surface 146 to reduce the light leakage.

In the embodiment, the light guide module 130 further includes a plurality of light diffusing microstructures 147 disposed between the first surface 142 and the second surface 144. Specifically, the light diffusing microstructures 147 are doped in the flexible light guide sheet 140 and the light diffusing microstructures 147 are, for example, a plurality of scattering particles having light scattering function. In addition, in the embodiment, the light source apparatus 100 further includes at least one reflective element 210 (one reflective element 210 shown in FIG. 1A is exemplified) disposed on the second surface 144. The reflective element 210 is, for example, a reflective coating film on the second surface 144.

A portion of the light beam 112 entering the flexible light guide sheet 140 through the light incident surface 146 is repeatedly reflected by the first surface 142 and the reflective element 210. A scattering effect is generated when the light beam 112 strikes the light diffusing microstructures 147 such that a portion of the scattered light beam 112 may be transmitted out of the flexible light guide sheet 140 from the first surface 142 to achieve an illuminating effect. In the embodiment, the light guide module 130 further includes a plurality of prism structures 148 disposed on the first surface 142. The prism structures 148 are, for example, prism columns, wherein each of the prism structures 148 is, for example, extended in a direction perpendicular to the light incident surface 146 and the prism structures 148 are, for example, arranged in a direction parallel to the light incident surface 146. The prism structures 148 are capable of converging an angle of the emitted light to enhance the intensity of the emitted light.

The light shape adjustment element 150 is connected to the light guide module 130 and capable of changing a light shape of the emitted light from the light guide module 130. In the embodiment, the light shape adjustment element 150 is, for example, a shape adjusting and fixing element connected to the flexible light guide sheet 140. The shape adjusting and fixing element is capable of being deformed with a stress and being fixed in a plurality of various shapes so that the flexible light guide sheet 140 is fixed in the plurality of various shapes by the shape adjusting and fixing element. Specifically, in the embodiment, the shape adjusting and fixing element includes a plurality of fixing frames 152 and two adjacent fixing frames 152 are hinged to each other, such as hinged to each other through a hinge 154. The two adjacent fixing frames 152 are capable of rotating relative to each other and the flexible light guide sheet 140 is fixed in the fixing frames 152. In the embodiment, the fixing frames 152 have trenches 156, and edges of the flexible light guide sheet 140 are disposed in the trenches 156. Accordingly, the flexible light guide sheet 140 is fixed by the fixing frames 152. When the two adjacent fixing frames 152 rotate relative to each other, the flexible light guide sheet 140 may be changed between a spreading plane state and a gathering continuous V-shape state, and may also be bended to present in various shapes (such as an arc shape or kinds of snake shapes). As such, the light shape adjustment element 150 may be conducive to adjust the light shape of the emitted light beam 112 from the first surface 142 to change the shapes of the illuminating regions and the illuminance distribution. Therefore, the user may adjust the light shape of the emitted light to the optimized manner according to different situations through the light shape adjustment element 150.

In the embodiment, the light source apparatus 100 further includes a base 160 and a holder 170. The base 160 has a first accommodating space 162 inside to accommodate the light source 110 and the light incident ends 122 of the optical fibers 120. The holder 170 is disposed on the base 160 and the holder 170 has a second accommodating space 172 inside to accommodate a portion of the optical fibers 120, wherein the light incident ends 122 and the light emitting ends 124 of the optical fibers 120 are respectively stretched out of two opposite ends of the second accommodating space 172.

In the light source apparatus 100 of the embodiment, the light source 110 is disposed in the base 160 and the base 160 is usually leaned against a table surface, the ground, or other objects. Therefore, the heat generated from the light source 110 dissipates not only through the air, but also through the base 160 for conducting to the table surface, the ground or other objects so as to achieve a heat dissipation effect better than the heat dissipation effect through the air. In addition, the disposition location of the base 160 is relatively farther from the head of the user so that the user rarely feels uncomfortableness due to the increasing of the surrounding temperature. Additionally, the volume of the base 160 is not restricted so that the surface area of the base 160 is designed to be enlarged to further enhance the heat dissipation effect.

In the embodiment, the light source apparatus 100 further includes a lens 180 disposed in the transmission path of the light beam 112 and located between the light source 110 and the light incident ends 122 of the optical fibers 120. The lens 180 is conducive to converge the light beam 112 at the light incident ends 122 of the optical fibers 120 to achieve higher light utilization. In the embodiment, the light source apparatus 100 further includes a reflective lampshade 190. The light source 110 is disposed in the reflective lampshade 190 and the reflective lampshade 190 is capable of reflecting the light beam 112 emitted from the light source 110 to the light incident ends 122 of the optical fibers 120 to enhance the light utilization.

The light source apparatus of the embodiment is similar to the light source apparatus 100 in FIG. 1A and the difference between the two light source apparatuses is described below. In the embodiment, the light diffusing microstructures 147a and 147b of the light guide module 130a are respectively located at the second surface 144a and the first surface 142a of the flexible light guide sheet 140a. In addition, the light diffusing microstructures 147a and 147b are, for example, protruding points on the surface of the flexible light guide sheet 140a. However, in other embodiments, the light diffusing microstructures may be concaving points, protruding stripes, concaving stripes, or diffusing particles on the surface of the flexible light guide sheet. In other embodiments, the light diffusing microstructures may be located at least one of the positions such as inside the flexible light guide sheet, at the first surface, and at the second surface. Moreover, in the embodiment, the reflective element 210a is a reflective sheet.

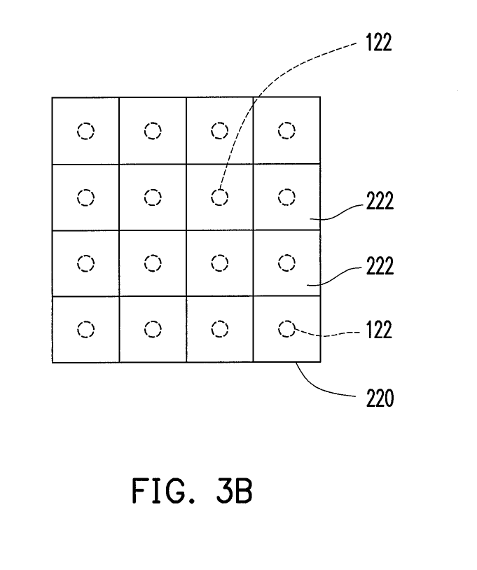

Referring to FIG. 3A and FIG. 3B, the light source apparatus of the embodiment is similar to the light source apparatus 100 in FIG. 1A and the difference between the two light source apparatuses are described below. In the light source apparatus of the embodiment, a lens array 220 is used to replace the lens 180 in FIG. 1A. The lens array 220 is disposed in the transmission path of the light beam 112 and located between the light source 110 and the light incident end 122 of each optical fiber 120. In the embodiment, the lens array 220 has a plurality of lens units 222 disposed in an array, the light incident ends 122 of the optical fibers 120 are also arranged in an array, and the lens units 222 are capable of respectively converging the light beam 112 at the light incident ends 122 of the optical fibers 120. Accordingly, the light beam 112 transmitted to the area between the light incident ends 122 of two adjacent optical fibers 120 and incapable of being efficiently utilized is reduced, so the light utilization is enhanced.

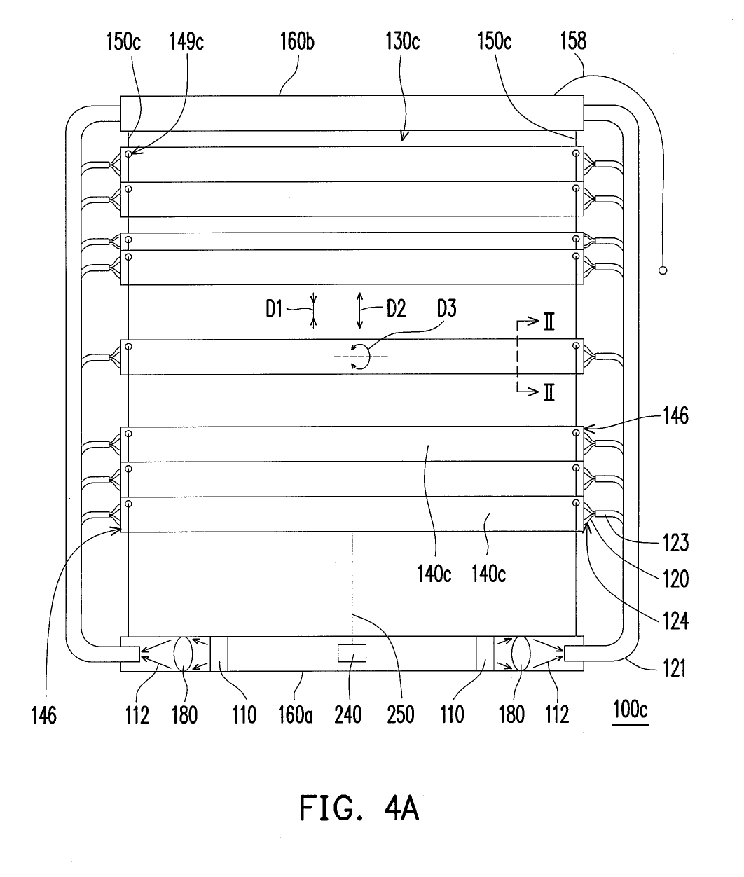

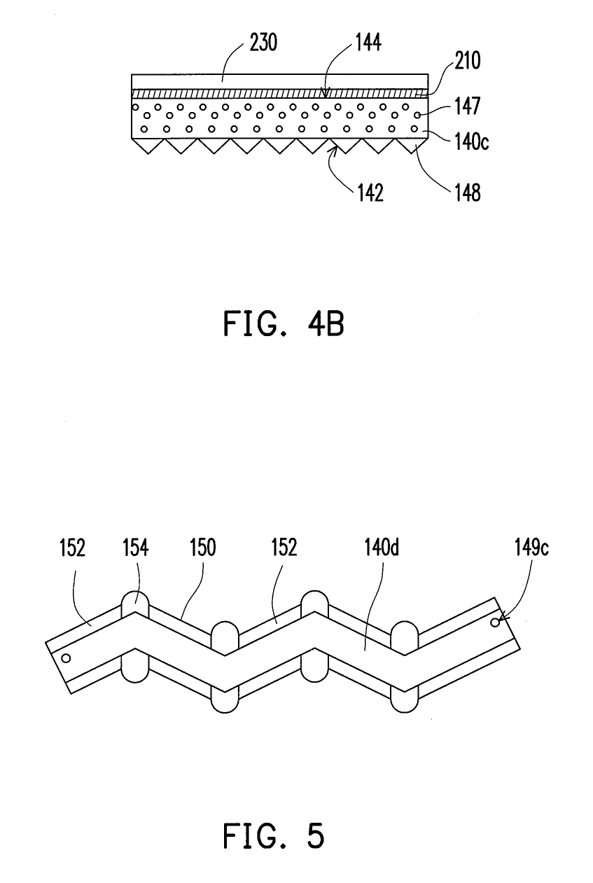

Referring to FIG. 4A and FIG. 4B, the light source apparatus 100c of the embodiment is similar to the light source apparatus 100 in FIG. 1A and the difference between the two light source apparatuses are described below. The light guide module 130c in the light source apparatus 100c of the embodiment includes a plurality of light guide sheets 140c, and each of the light guide sheets 140c has one first surface 142, one second surface 144, and at least one light incident surface 146 as shown in FIG. 1A (two light incident surfaces 146 are exemplified in FIG. 4A). The light incident surfaces 146 of each light guide sheet 140c receive the light beam 112 emitted from the light emitting end 124 of at least one of the optical fibers 120. In the embodiment, when the optical fiber bundle 121 is stretched beside each of the light incident surfaces 146, one sub-optical fiber bundle 123 is forked from the optical fiber bundle 121. The sub-optical fiber bundle 123 is also including a plurality of optical fibers 120. Thereafter, the sub-optical fiber bundle 123 is forked into a plurality of optical fibers 120 having the light emitting ends 124, and the light emitting ends 124 are separated from each other, arranged along a straight line, and located beside the light incident surfaces 146. However, in other embodiments, when the optical fiber bundle 121 is stretched beside each of the light incident surfaces 146, merely one optical fiber 120 is forked from the optical fiber bundle 121 to reach the corresponding light incident surface 146. In the embodiment, the light emitting ends 124 of the optical fibers 120 and the light incident surfaces 146 are connected with each other. Moreover, in the embodiment, the light guide sheets 140c may be flexible or rigid light guide sheets.

In addition, in the embodiment, the light shape adjustment element 150c is a position adjustment element, the light shape adjustment element 150c is connected to the light guide sheets 140c, and the light shape adjustment element 150c is conducive to adjust the relative positions of the light guide sheets 140c. Specifically, in the embodiment, the position adjustment element 150c is a rope set serially connecting the light guide sheets 140c, wherein the rope set is capable of passing through the through holes 149c on the light guide sheets 140c to serially connect the light guide sheets 140c. The position of the rope set is capable of being changed to drive the relative positions of the light guide sheets 140c to change. The rope set is similar to a rope set used for controlling shutters to open-close and to rotate. The rope set is conducive to gather the light guide sheets 140c in the direction D1 to form a relative small light emitting area or spread the light guide sheets 140c in the direction D2 to form a relative large light emitting area. In addition, the rope set may also be designed to make each light guide sheet 140c rotate along the direction D3. Accordingly, the light shape is changed through changing the relative positions of the light guide sheets 140c to further adjust the shape of the illuminated region and the luminance distribution. Furthermore, the light shape adjustment element 150c may have a controller 158 so that the user controls the open-close and the rotation of the light guide sheets 140c through the controller 158. The controller 158 may be a rope, a control rod, or a combination thereof.

In the embodiment, a fixing bar 160a is used for replacing the base 160 in FIG. 1A, and the light source 110 and the lens 180 are disposed inside the fixing bar 160a. In addition, the rope set is also connected to the fixing bar 160a. In the embodiment, the light source apparatus 100c further includes at least one solar energy collector 230 (a plurality of solar energy collectors 230 are exemplified in the embodiment). The solar energy collectors 230 are respectively disposed on the reflective elements 210 and the reflective elements 210 are disposed between the second surface 144 and the solar energy collector 230. The solar energy collectors 230 are connected to a rechargeable battery 240 through the conductive lines 250. Accordingly, during daytime, the user may spread the light source apparatus 100c configured on the window and make the solar energy collector 230 face outward of the window (i.e. face to the direction pointing into the drawing sheet of FIG. 4A) to achieve a shading effect and simultaneously convert the solar energy into the electrical energy to store the electrical energy in the rechargeable battery 240. During nighttime, the user may make the light source apparatus 100c illuminate by using the electrical energy stored in the rechargeable battery 240 and make the first surfaces 142 face to interior (i.e. face to the direction away from the drawing sheet of FIG. 4A) to achieve the illuminating effect. The power saving effect is achieved to comply with the trend of environmental protection. Nevertheless, the light source 110 of the light source apparatus 100c may be connected to an outer power, such as commercial power, through the conductive lines to make the light source 100 illuminate. In addition, another fixing bar 160b may be disposed at another side opposite to the fixing bar 160a and the another fixing bar 160b is used for holding the rope set.

The extending direction of the light guide sheets 140c is not limited to the horizontal direction in the invention. In other embodiments, each of the light guide sheets 140c may also be extended in a vertical direction or in an oblique direction. Furthermore, in another embodiment, the disposition of the reflective element 210 and the solar energy collector 230 on the second surface 144 of the light guide sheet 140c may be omitted and the light beam 112 is emitted from the first surface 142 and the second surface 144 simultaneously. Therefore, the light source apparatus may be served as a curtain capable of illuminating at two sides so that the light source apparatus is conducive to provide a decoration effect and beautify the environment when the light source apparatus is illuminating.

Referring to FIG. 5, the light source apparatus of the embodiment is similar to the light source apparatus in FIG. 4A and the difference between the two light source apparatus lies in that the light shape adjustment element of the embodiment further includes the light shape adjustment element 150 in FIG. 1A (i.e. the shape adjusting and fixing element) in addition to the light shape adjustment element 150c in FIG. 4A (i.e. the rope set). The light guide sheet 140d in FIG. 5 is a flexible light guide sheet and the light guide sheet 140d and the light shape adjustment element 150 illustrated in FIG. 5 are used for replacing each of the light guide sheets 140c in FIG. 4A. Similar to the light shape adjustment element 150 illustrated in FIG. 1A, the light shape adjustment element 150 of the embodiment is capable of being deformed with a stress and be fixed in a plurality of various shapes so that the flexible light guide sheet 140d is fixed in the plurality of various shapes through the shape adjustment element 150. Accordingly, the rope set is used for changing the relative positions of the flexible light guide sheets 140d and the light shape adjustment element 150 is used for changing the shape of each light guide sheet 140d so that the combination of the change of the positions and the change of the shapes makes the light shape of the emitted light be varied.

In summary, the light source apparatus according to an embodiment of the invention has at least one of the following effects: the light source apparatus according to an embodiment of the invention has a light shape adjustment element connected to the light guide module and the light shape adjustment element is capable of changing the light shape of the emitted light from the light guide module so that the user may change the light shape of the emitted light emitted from the light source apparatus according to an embodiment of the invention through operating the light shape adjustment element so as to form the illuminating regions having different shapes and illuminance distribution.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A light source apparatus, comprising:
at least one light source capable of emitting a light beam;
at least one optical fiber disposed in a transmission path of the light beam, wherein the optical fiber has a light incident end and a light emitting end opposite to the light incident end, and the light beam is capable of entering the optical fiber through the light incident end and leaving the optical fiber through the light emitting end;
a light guide module having at least one first surface, at least one second surface opposite to the first surface, and at least one light incident surface connecting the first surface and the second surface, wherein the light beam from the light emitting end is capable of entering the light guide module through the light incident surface; and
a light shape adjustment element connected to the light guide module and capable of changing a light shape of an emitted light from the light guide module.

2. The light source apparatus according to claim 1, wherein the light guide module comprises a flexible light guide sheet having the first surface, the second surface, and the light incident surface, the light shape adjustment element comprises a shape adjusting and fixing element connected to the flexible light guide sheet, and the shape adjusting and fixing element is capable of being deformed with a stress and being fixed in a plurality of various shapes, such that the flexible light guide sheet is fixed in the plurality of various shapes through the shape adjusting and fixing element.

3. The light source apparatus according to claim 2, wherein the shape adjusting and fixing element comprises a plurality of fixing frames, adjacent two of the fixing frames are hinged to each other, and the flexible light guide sheet is fixed in the fixing frames.

4. The light source apparatus according to claim 1, wherein the at least one optical fiber is a plurality of optical fibers, the at least one first surface is a plurality of first surfaces, the at least one second surface is a plurality of second surfaces, the at least one light incident surface is a plurality of light incident surfaces, the light guide module comprises a plurality of light guide sheets, each of the light guide sheets has one of the plurality of first surfaces, one of the plurality of second surfaces, and at least one of the light incident surfaces, and the light incident surface of each of the light guide sheets is capable of receiving the light beam from the light emitting end of at least one of the optical fibers.

5. The light source apparatus according to claim 4, wherein the light shape adjustment element comprises a position adjustment element connected to the light guide sheets and capable of adjusting relative positions of the light guide sheets.

6. The light source apparatus according to claim 5, wherein the position adjustment element is a rope set serially connecting the light guide sheets, a position of the rope set is capable of being changed to drive the relative positions of the light guide sheets to change.

7. The light source apparatus according to claim 5, wherein each of the light guide sheets is a flexible light guide sheet, the light shape adjustment element further comprises a plurality of shape adjusting and fixing elements respectively connected to the flexible light guide sheets, and each of the shape adjusting and fixing elements is capable of being deformed with a stress and being fixed in a plurality of various shapes, such that each of the flexible light guide sheets is fixed in the plurality of various shapes through the corresponding shape adjusting and fixing element.

8. The light source apparatus according to claim 7, wherein each of the shape adjusting and fixing elements comprises a plurality of fixing frames, adjacent two of the fixing frames are hinged to each other for rotating relative to each other, and each of the flexible light guide sheets is fixed in the fixing frames of the corresponding shape adjusting and fixing element.

9. The light source apparatus according to claim 1, wherein the at least one optical fiber is a plurality of optical fibers and the optical fibers form an optical fiber bundle.

10. The light source apparatus according to claim 1, wherein the light emitting ends of the optical fibers are arranged beside the light incident surface along a straight line.

11. The light source apparatus according to claim 1, further comprising at least one reflective element disposed on the second surface.

12. The light source apparatus according to claim 11, further comprising at least one solar energy collector disposed on the reflective element, wherein the reflective element is disposed between the second surface and the solar energy collector.

13. The light source apparatus according to claim 1, further comprising:
a base, wherein the base has a first accommodating space inside to accommodate the light source and the light incident end of the optical fiber; and
a holder disposed on the base, wherein the holder has a second accommodating space inside to accommodate a portion of the optical fiber, wherein the light incident end and the light emitting end of the optical fiber respectively stretch out of two opposite ends of the second accommodating space.

14. The light source apparatus according to claim 1, further comprises a lens disposed in the transmission path of the light beam and located between the light source and the light incident end of the optical fiber.

15. The light source apparatus according to claim 1, further comprising a reflective lampshade, wherein the light source is disposed in the reflective lampshade, and the reflective lampshade is capable of reflecting the light beam emitted from the light source to the light incident end of the optical fiber.

16. The light source apparatus according to claim 1, wherein the at least one optical fiber is a plurality of optical fibers, the light source apparatus further comprises a lens array disposed in the transmission path of the light beam and located between the light source and the light incident end of each of the optical fibers, and the lens array has a plurality of lens units arranged in array and capable of respectively converging the light beam at the light incident ends of the optical fibers.

17. The light source apparatus according to claim 1, wherein the light guide module further comprises a plurality of prism structures disposed on the first surface.

18. The light source apparatus according to claim 1, wherein the light guide module further comprises a plurality of light diffusing microstructures disposed on the first surface, on the second surface, or between the first surface and the second surface.
